(19) United States
(12) Patent Application Publication
(10) Pub. No.: US 2019/0286978 A1
(43) Pub. Date: Sep. 19, 2019

(54) USING NATURAL LANGUAGE PROCESSING AND DEEP LEARNING FOR MAPPING ANY SCHEMA DATA TO A HIERARCHICAL STANDARD DATA MODEL (XDM)

(71) Applicant: Adobe Inc., San Jose, CA (US)

(72) Inventors: Milan Aggarwal, Delhi (IN); Balaji Krishnamurthy, Noida (IN); Shagun Sodhani, Delhi (IN)

(21) Appl. No.: 15/921,369

(22) Filed: Mar. 14, 2018

(51) Int. Cl. G06N 3/08; G06F 17/30; G06N 7/00

(52) U.S. Cl. CPC G06N 3/08; G06N 7/005; G06F 17/30294

(57) ABSTRACT

Systems and techniques map an input field from a data schema to a hierarchical standard data model (XDM). The XDM includes a tree of single XDM fields and each of the single XDM fields includes a composition of single level XDM fields. An input field from a data schema is processed by an unsupervised learning algorithm to obtain a sequence of vectors representing the input field and a sequence of vectors representing single level hierarchical standard data model (XDM) fields. These vectors are processed by a neural network to obtain a similarity score between the input field and each of the single level XDM fields. A probability of a match is determined using the similarity score between the input field and each of the single level XDM fields. The input field is mapped to the XDM field having the probability of the match with a highest score.

### TECHNICAL FIELD

This description relates to using natural language processing and deep learning for mapping any schema data to a hierarchical standard data model (XDM).

### BACKGROUND

Creating a standardized view of data is a challenging and important task while developing data oriented applications. The actual data can belong to different data sources which may have different schema and naming conventions, depending upon the source, even for data which is semantically the same or related. For example, different social media platforms may store information such as the identification (id) of the user who publishes a post but may use different column names in their schema to store this information. For instance, one social media platform may use ‘user id’ while the other social media platform may use ‘customer id’. This difference in the naming convention is superficial for any application which aims to use this data and may lead to unnecessary confusion. Due to the different column names for the same data, some downstream application might unexpectedly treat ‘user id’ and ‘customer id’ differently while implementing an algorithm on the data. This problem will not arise if semantically related data, that is, data belonging to different sources as described above, is mapped to a standardized column. In that case, the downstream application will not treat them differently and can apply the algorithm uniformly on the standardized column. This is precisely what the Standard Data Model(XDM) does.

The Standard Data Model (XDM) is a standard hierarchical schema to which any kind of data can be mapped. XDM allows smooth integration of data into a standard schema so that the applications may work seamlessly across multiple data sources and customers. This enables the usage of an integrated dataset across different data related use-cases in a lossless manner. For instance in the above example, ‘user id’ and ‘customer id’ can be mapped to ‘person id’ in XDM schema.

Technical problems arise when attempting to map any input data field to an XDM field. For instance, this mapping is a non-trivial task since the mapping requires domain knowledge of both the input field (original schema to which it belongs) as well as the hierarchies in the XDM schema. Mismatches may occur while doing this mapping, which is undesirable. Secondly, the raw input fields may have no information about the semantics and may have generalized names such as var1, var2, etc. In situations where the input fields have generalized names and do not include semantic information, then other sources of information, such as the description of the input field, may have to be read and comprehended to be able to map these input fields to an XDM field. Also, the input schema can have many fields and manually mapping each one of them is time consuming and is not scalable.

Furthermore, existing system architectures and techniques may not transform text data to hierarchical taxonomies without placing restrictions on the depth and breadth of the hierarchy.

The above technical problems, as well as other technical problems, raise the need of a technical solution that is applicable across different domains and can save time by bypassing human intervention and automating the process of mapping any input schema containing arbitrary entities and fields to hierarchical XDM.

### SUMMARY

This document describes a system and techniques for a deep learning architecture which can map any input field to an hierarchical XDM using natural language processing on the textual data obtained from the names and the descriptions of the input fields. The three phase neural network architecture disclosed herein enables transformation of text data into a multi-tiered XDM hierarchy. In contrast to previous mappings, which could only address a top level XDM transformation, the system and techniques create a new architecture that first maps input fields to XDM fields, but then predicts a similarity score for the mapped XDMs, and then calculates the overall probability of a match to predict the fields in the hierarchy.

In one general aspect, systems and techniques map an input field from a data schema to a hierarchical standard data model (XDM). The XDM includes a tree of single XDM fields and each of the single XDM fields includes a composition of single level XDM fields. An input field from a data schema is processed by an unsupervised learning algorithm to obtain a sequence of vectors representing the input field and a sequence of vectors representing single level hierarchical standard data model (XDM) fields. These vectors are processed by a neural network to obtain a similarity score between the input field and each of the single level XDM fields. A probability of a match is determined using the similarity score between the input field and each of the single level XDM fields. The input field is mapped to the XDM field having the probability of the match with a highest score.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system 100 for mapping any schema data to a hierarchical standard data model (XDM).

FIG. 2 is a block diagram of the mapping module of FIG. 1 illustrating an architecture for the mapping module for mapping any schema data to XDM.

FIG. 3 is a flowchart illustrating example operations of the system of FIG. 1.

FIG. 4 is an example screenshot of a user interface for mapping an input field to an XDM field.

FIG. 5 is an example screenshot of the user interface of FIG. 4 for mapping an input field to an XDM field with an XDM field match.

FIG. 6 is an example screenshot of a user interface for uploading a file of input fields for mapping to XDM fields.

FIG. 7 is an example screenshot of a user interface of results of multiple input fields mapping to respective XDM fields.

FIG. 8 is an example screenshot of the user interface of FIG. 7 illustrating the XDM fields and the option to update the mapped XDM field.

### DETAILED DESCRIPTION

This document describes a system and techniques for a deep learning architecture which can map any input field to an hierarchical XDM using natural language processing on the textual data obtained from the names and the descriptions of the input fields. The three phase neural network architecture disclosed herein enables transformation of text data into a multi-tiered XDM hierarchy. In contrast to previous mappings which could only address a top level XDM transformation, the system and techniques create a new architecture that first maps input fields to XDM fields, but then predicts a similarity score for the mapped XDMs, and then calculates the overall probability of a match to predict the fields in the hierarchy. In order to map a given input field to a hierarchical XDM field, the names and descriptions of input fields and target XDM fields are processed to determine the probability of match with the corresponding XDMs. To determine the matching probability with a single XDM field, a single path in an XDM tree, a similarity score between the input field and each node (single level XDM) in the path is computed. The similarity scores are then composed and to determine the probability of match between the input field and a single XDM field.

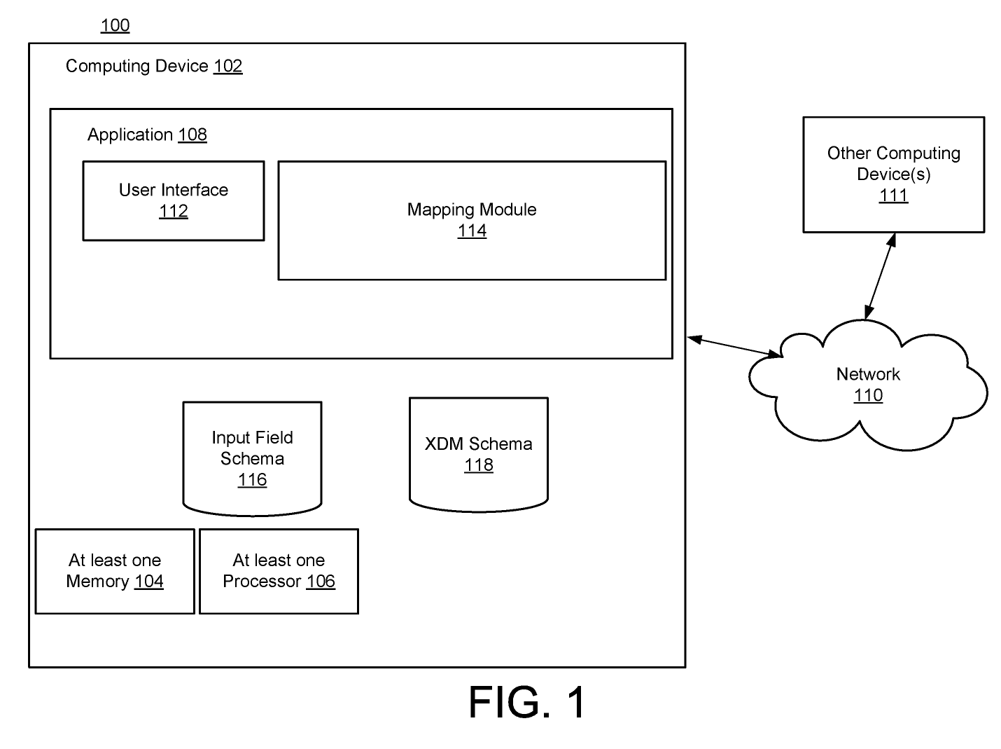

The system and techniques may use one or more phases to map a given input field to a hierarchical XDM field. For example, in a first phase, an unsupervised algorithm, such as GloVe, is used to obtain a vector representation of each word in the names and descriptions of the input field and single level XDMs. In a second phase, a supervised model uses a long short-term memory (LSTM) model and a neural network to process the vector representations obtained in the first phase to determine a similarity score between the input field and single level XDMs. In a third phase, the similarity scores of the input field are composed with the single level XDMs, which together constitute a single XDM field—single path in XDM tree, to compute the probability of a match with the corresponding XDM field. This is repeated for different XDM fields such that the input field is mapped to the XDM field having the highest matching probability. Each phase is discussed in more detail below with respect to FIG. 1.

The system and techniques enable an automated process to migrate and map data (e.g., customer data) from different sources, using different schema to a centralized standard database using XDM. The system and techniques provide for a fast, efficient, scalable and seamless integration of data to XDM to enable downstream applications using XDM to consume the data. A technical improvement is realized by a computer platform, such as a cloud network platform having multiple different applications, using XDM to automatically convert data from different schemas to XDM for use by the many different applications using XDM. The system and techniques eliminate the need for expertise to map input fields to XDM manually. Moreover, the system and techniques assigns input fields to hierarchical XDMs, not just top level XDMs only, without placing any restrictions on the depth and breadth of the hierarchy. Additionally, there are no restrictions on the size, such as the number of words, on a name of the input field and a description of the input field. As mentioned above, if the input field does not have a name, the input field can still be automatically mapped to the appropriate XDM field using the description of the input field.

Advantageously, the system and techniques can map input fields to custom XDM fields on which the LSTM model and/or the neural network have not been trained during training of the models. The models are designed to determine a similarity score between input field and single level XDMs without placing a constraint on the number and specificity of XDMs. The models accomplish this because the models determine similarity scores with all of the single level XDMs in the second phase so the number of XDM fields, which are paths of single level XDMs, aren't constrained because the neural network is only processing the similarity scores for the single level XDMs. Then, in the third phase, the similarity scores of the all single level XDMs in one path in the tree, which represent a single XDM field, are composed to determine the final probability score to find the best match to the input field. This flexibility is particularly advantageous since it is robust to the XDM evolution and can be used to provide suggestions while mapping input fields to new custom XDM fields without any change in the models.

Additionally, the system and techniques provide ranked suggestions about the matched XDM fields based on a matching score between the input field and the XDM fields. The system, including the LSTM model and the neural network, can receive feedback on its predictions from a user. This feedback can then be used to further fine-tune the LSTM model and/or the neural network based on the ranking feedback received.

In contrast with prior systems and techniques, the current system and techniques described in this document are not rule-based and do not use rules that use ad hoc heuristics and regular expression matching for mapping input fields to XDM fields. Such rule-based techniques do not capture semantics while performing the mapping and only can process a finite number of cases and are not generalizable and applicable to different domains. Also, such prior systems and techniques require a lot of time to fabricate mapping rules, which cannot be extended to evolving and custom XDM fields.

As used herein, XDM comprises of a hierarchical schema where an entity (named collection of fields) may have a field which itself is an entity. For example, ‘product’ can be an entity with ‘price’ as one attribute and ‘manufacturer’ as another attribute such that manufacturer itself is an entity with attributes such as name, address etc. Thus, the entire XDM schema can be viewed as a hierarchical tree. Any node in the XDM tree can be considered as a single level XDM. A node in the XDM tree may be referred to as a leaf if it is an attribute and not an entity. On the other hand, a node in the XDM tree is non-leaf if it represents an entity containing attributes which can be leaf or non-leaf. It can be noted that a path from root to a leaf node in the XDM hierarchical tree represents a single XDM field. Traversing through different paths in this tree yields different XDM fields to which input fields can be mapped. For instance, ‘product.manufacturer.name’ is a complete path and represents a single XDM field with ‘product’, ‘manufacturer’ and ‘name’ being single level XDMs. ‘name’ is a leaf node while the other two are XDM entities (non-leaf nodes).

In general, neural networks, especially deep neural networks have been very successful in modeling high-level abstractions in data. As used herein, neural networks are computational models used in machine learning made up of nodes organized in layers. The nodes are also referred to as artificial neurons, or just neurons, and perform a function on provided input to produce some output value. A neural network requires a training period to learn the parameters, i.e., weights, used to map the input to a desired output. The mapping occurs via the function. Thus, the weights are weights for the mapping function of the neural network.

Each neural network is trained for a specific task, e.g., field mapping, image upscaling, prediction, classification, encoding, etc. The task performed by the neural network is determined by the inputs provided, the mapping function, and the desired output. Training can either be supervised or unsupervised. In supervised training, training examples are provided to the neural network. A training example includes the inputs and a desired output. Training examples are also referred to as labeled data because the input is labeled with the desired output. The neural network learns the values for the weights used in the mapping function that most often result in the desired output when given the inputs. In unsupervised training, the neural network learns to identify a structure or pattern in the provided input. In other words, the neural network identifies implicit relationships in the data. Unsupervised training is used in deep neural networks as well as other neural networks and typically requires a large set of unlabeled data and a longer training period. Once the training period completes, the neural network can be used to perform the task it was trained for.

In a neural network, the neurons are organized into layers. A neuron in an input layer receives the input from an external source. A neuron in a hidden layer receives input from one or more neurons in a previous layer and provides output to one or more neurons in a subsequent layer. A neuron in an output layer provides the output value. What the output value represents depends on what task the network is trained to perform. Some neural networks predict a value given in the input. Some neural networks provide a classification given the input. When the nodes of a neural network provide their output to every node in the next layer, the neural network is said to be fully connected. When the neurons of a neural network provide their output to only some of the neurons in the next layer, the network is said to be convolutional. In general, the number of hidden layers in a neural network varies between one and the number of inputs.

To provide the output given the input, the neural network must be trained, which involves learning the proper value for a large number (e.g., millions) of parameters for the mapping function. The parameters are also commonly referred to as weights as they are used to weight terms in the mapping function. This training is an iterative process, with the values of the weights being tweaked over thousands of rounds of training until arriving at the optimal, or most accurate, values. In the context of neural networks, the parameters are initialized, often with random values, and a training optimizer iteratively updates the parameters, also referred to as weights, of the network to minimize error in the mapping function. In other words, during each round, or step, of iterative training the network updates the values of the parameters so that the values of the parameters eventually converge on the optimal values.

As used herein, a Long Short-Term Memory (LSTM) model is a variation of a recurrent neural network capable of learning long-term dependencies. A recurrent neural network (or recurrent net) is a type of neural network designed to recognize patterns in sequences of data, such as text, genomes, handwriting, the spoken word, or numerical times series data. Recurrent networks take as their input not just the current input example they see, but also what they have perceived previously in time. LSTMs models are sequence models which are used for processing a sequence of inputs of arbitrary length to obtain a representation which capture and incorporate long term dependencies within the sequence.

As used herein, an unsupervised learning algorithm is an algorithm for obtaining vector representations for words. One example of an unsupervised learning algorithm is Global Vectors for Word Representation (GloVe). GloVe uses aggregated global word-word co-occurrence statistics from a large corpus. GloVe is used to represent words as geometric encodings in a vector space by performing dimensionality reduction on the co-occurrence matrix. The vector representation captures the semantics between words as well as the context in which they appear. Since GloVe is an unsupervised algorithm, it provides flexibility in choosing the corpus over which the word vectors are trained. For instance, a corpus may be selected based on the domain relevant to the data and the input fields and XDM fields.

In one implementation, the corpus used to train the unsupervised learning algorithm is from a digital marketing domain. For example, one corpus used from the digital marketing domain includes textual data available under the digital marketing category from Wikipedia for learning the word vectors. This textual data is used since names and descriptions of both the input fields and target XDMs comprise words which are commonly used in digital marketing domain. This allows for obtaining better word vectors which generalizes well over words commonly used in a digital marketing domain. In some implementations, the corpus is selected from one or more domains other than the digital marketing domain.

FIG. 1 is a block diagram of a system 100 for mapping any schema data to a hierarchical standard data model (XDM). The system 100 includes a computing device 102 having at least one memory 104, at least one processor 106 and at least one application 108. The computing device 102 may communicate with one or more other computing devices 111 over a network 110. The computing device 102 may be implemented as a server, a desktop computer, a laptop computer, a mobile device such as a tablet device or mobile phone device, as well as other types of computing devices. Although a single computing device 102 is illustrated, the computing device 102 may be representative of multiple computing devices in communication with one another, such as multiple servers in communication with one another being utilized to perform its various functions over a network.

The at least one processor 106 may represent two or more processors on the computing device 102 executing in parallel and utilizing corresponding instructions stored using the at least one memory 104. The at least one memory 104 represents a non-transitory computer-readable storage medium. Of course, similarly, the at least one memory 104 may represent one or more different types of memory utilized by the computing device 102. In addition to storing instructions, which allow the at least one processor 106 to implement the application 108 and its various components, the at least one memory 104 may be used to store data, such as one or more of the objects or files generated by the application 108 and its components.

The network 110 may be implemented as the Internet, but may assume other different configurations. For example, the network 110 may include a wide area network (WAN), a local area network (LAN), a wireless network, an intranet, combinations of these networks, and other networks. Of course, although the network 110 is illustrated as a single network, the network 110 may be implemented as including multiple different networks.

The application 108 may be accessed directly by a user of the computing device 102. In other implementations, the application 108 may be running on the computing device 102 as a component of a cloud network where a user accesses the application 108 from another computing device, such other computing device(s) 111, over a network, such as the network 110. In one implementation, the application 108 may be an application for mapping input fields from a data schema to XDM. The application 108 may be a standalone application that runs on the computing device 102. Alternatively, the application 108 may be an application that runs in another application such as a browser application or be a part of a suite of applications running in a cloud environment.

The application 108 includes at least a user interface 112 and a mapping module 114. The application 108 enables a user to map (or convert) data arranged as part of one data schema to a standardized data schema. In this manner, the data is transformed for use by either the application 108 or other applications that use the standardized data schema. The actual data can belong to different data sources, which may have different schema and naming conventions, even for data which is semantically the same or related, as discussed above. In the application 108, the mapping module 114 maps (or converts) the input fields from the input field schema 116 (or a first data schema) to the fields of the XDM schema 118. The input field schema 116 may be a database that is organized according to a particular arrangement and field naming convention. The input field schema 116 is different from the XDM schema 118.

The XDM schema 118 is a standard hierarchical schema to which any kind of data can be mapped. The XDM schema 118 allows smooth integration of data into a standard schema so that the applications using XDM may work seamlessly across multiple data sources and customers. The XDM schema 118 includes a hierarchical schema where an entity (named collection of fields) may have a field which itself is an entity. For example, ‘product’ can be an entity with ‘price’ as one attribute and ‘manufacturer’ as another attribute such that manufacturer itself is an entity with attributes such as name, address etc. Thus, the entire XDM schema can be viewed as a hierarchical tree. Any node in the XDM tree can be considered as a single level XDM. A node in the XDM tree may be referred to as a leaf if it is an attribute and not an entity. On the other hand, a node in the XDM tree is non-leaf if it represents an entity containing attributes which can be leaf or non-leaf. It can be noted that a path from root to a leaf node in the XDM hierarchical tree represents a single XDM field. Traversing through different paths in this tree yields different XDM fields to which input fields can be mapped. For instance, ‘product.manufacturer.name’ is a complete path and represents a single XDM field with ‘product’, ‘manufacturer’ and ‘name’ being single level XDMs. ‘name’ is a leaf node while the other two are XDM entities (non-leaf nodes).

While the input field schema 116 and the XDM schema 118 are illustrated in FIG. 1 as residing on the computing device 102, it is understood that the either or both of the input field schema 116 and the XDM schema 118 may reside on other computing devices such as computing device 111. For instance, the mapping module 114 may receive input fields to map to XDM fields from the input field schema 116, whether the input fields are resident on the computing device 102 or on a different computing device, such as computing device 111. Similarly, the mapping module 114 may provide any mapping output for display and/or storage on the computing device 102 and/or on other computing device 111.

Also, while only one input field schema 116 is illustrated in FIG. 1, it is understood that the mapping module 114 can map input fields from multiple different schemas to XDM schema 118. The mapping module 114 may process and automatically map fields from different schema to XDM such that similar fields from different schema are standardized.

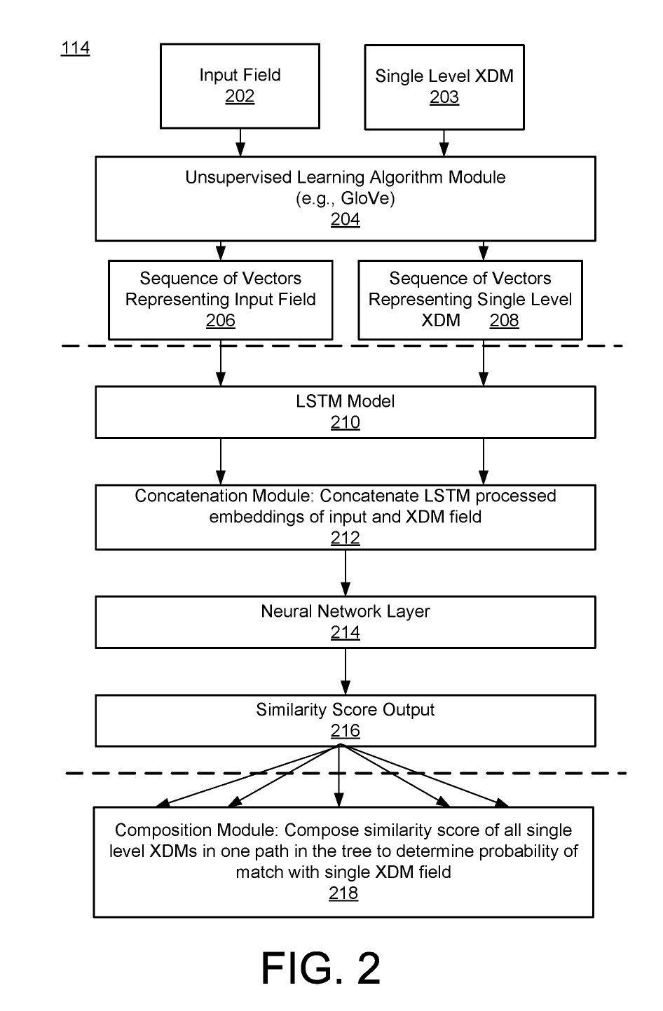

Referring also to FIG. 2, the mapping module 114 architecture is illustrated in more detail. The architecture of the mapping module 114 may be broken up into multiple phases. FIG. 2 illustrates the different phases through the use of a horizontal, broken line. The three phase neural network architecture disclosed herein enables transformation of text data into a multi-tiered XDM hierarchy. In contrast to previous mappings which could only address a top level XDM transformation, the system and techniques create a new architecture that first maps input fields to XDM fields, but then predicts a similarity score for the mapped XDMs, and then calculates the overall probability of a match to predict the fields in the hierarchy. In a first phase, the mapping module includes an unsupervised learning algorithm 204. The unsupervised learning algorithm 204 receives an input field 202 from a first data schema such as the input field schema 116. The unsupervised learning algorithm 204 also receives multiple single level XDM fields 203. The unsupervised learning algorithm 204 processes the input field 202 and obtains and outputs a sequence of vectors representing the input field 206 and a sequence of vectors representing multiple single level XDM fields 208. The input field 202 includes each word in the name and description of the input field. The unsupervised learning algorithm 204 obtains vector representations each word in the name and the description of the input field 202. If the input field 202 does not include a name, then the unsupervised learning algorithm 204 uses just the words in the description of the input field 202. Similarly, if the input field 202 does not include a description, then the unsupervised learning algorithm 204 uses just the words in the name of the input field 202. When the input field 202 includes both a name and a description, then the unsupervised learning algorithm 204 uses the words from both the name and the description of the input field 202.

As mentioned above, one example unsupervised learning algorithm 204 is GloVe. It is understood that other types of unsupervised learning algorithms may be used. The unsupervised learning model 204 (e.g., GloVe model) is trained for learning vector representation of words using a text corpus such as, for example, a publically available text corpus. GloVe is an unsupervised learning algorithm which uses word-word co-occurrence statistics over a large corpus. GloVe is used to represent words as geometric encodings in a vector space by performing dimensionality reduction on the co-occurrence matrix. The vector representation captures the semantics between words as well as the context in which they appear. Since GloVe is an unsupervised algorithm, it provides flexibility in choosing the corpus over which the word vectors are trained. In one implementation, textual data available under a digital marketing category from Wikipedia may be used since names and descriptions of both the input fields and target XDMs comprises of words which are commonly used in the digital marketing domain. This allows for obtaining better word vectors which generalizes well over words commonly used in digital marketing domain. Other text corpus from other domains may be used to train the unsupervised learning algorithm 204.

The unsupervised learning algorithm module 204 is then used for obtaining the sequence of vectors representing the input field 206, which are vector representations of words appearing in the input field. The sequence of vectors representing the input field 206 are then composed in the next phase to obtain the representation of the entire input field. Likewise, the unsupervised learning algorithm module 204 is used for obtaining a sequence of vectors representing single level XDMs 208, where a single vector is obtained for each single level XDM. These vectors are then used to obtain a similarity score between the input field and single level XDMs in the next phase.

In the next phase, the mapping module 114 includes an LSTM model 210, a concatenation module 212 and a neural network layer 214. The combination of the LSTM model 210, the concatenation module 212 and the neural network layer 214 may be referred to as the field similarity network. The combination of the LSTM model 210, the concatenation module 212 and the neural network layer 214 take as input the sequence of vectors representing the input field 206 and the sequence of vectors representing the single level XDMs 208 and output a similarity score output 216.

In the next phase, the output of the first phase is used to obtain vector representations of both the input field as well the single level XDM field by composing the word vectors of individual words appearing in their names and descriptions, which are then used to compute a similarity score between the input field and each of the single level XDM fields. The sequence of vectors representing the input field 206 and the sequence of vectors representing single level XDM fields 208 are input to the LSTM model 210. The LSTM model 210 is a variation of a recurrent neural network capable of learning long-term dependencies. A recurrent neural network (or recurrent net) is a type of neural network designed to recognize patterns in sequences of data, such as text, genomes, handwriting, the spoken word, or numerical times series data. Recurrent networks take as their input not just the current input example they see, but also what they have perceived previously in time. LSTM models are sequence models which are used for processing a sequence of inputs of arbitrary length to obtain a representation which capture and incorporate long term dependencies within the sequence.

To obtain vector representation of an input field 202, the sequence of vectors representing the input field 206, corresponding to words in the name and description of the input field are augmented as <name_{word vectors}: description_{word vectors}> and given as a sequential input to the LSTM model 210. The order in which the words appear in the name and description of the input field 202 determine the order in which the corresponding sequence of vectors representing the input field 206 are input to the LSTM model 210. The LSTM model 210 outputs a vector representing the entire input field 202. The output of the LSTM model 210 is used as the vector representing the entire input field. Likewise, the sequence of vectors representing the single level XDMs 208 is input into the LSTM model 210. The LSTM model 210 outputs a vector representing the single level XDM.

The concatenation module 212 concatenates the input field vector output from the LSTM model 210 with the vector representing the single level XDM output from the LSTM model 210. The concatenation module 212 outputs a concatenated vector. The concatenated vector is given as input to the neural network layer 214.

The neural network layer 214 may include one or more neural network layers through which the concatenated vector is processed. For example, the concatenated vector may be processed through a fully connected neural network layer, which may be referred to as a dense neural network layer. The output of the dense neural network layer may be input to a second neural network layer, which also may be a fully connected neural network layer. The second neural network layer, which may be of size 1, processes the output of the dense neural network layer and predicts a similarity score as an output. In some implementations, ‘sigmoid’ activation may be used over the output of the final neural network layer to obtain the final similarity score. This similarity score represents a probability of a match between the input field and a single level XDM field.

In some implementations, the field similarity network, which includes the LSTM model 210, the concatenation module 212 and the neural network layer 214, may all be part of a single neural network. The single neural network may include multiple different layers that perform one or more of the various functions of the second phase. In some implementations, the field similarity network may be part of multiple neural networks. Each of the different neural networks may perform one or more of the various functions of the second phase. In either case, the field similarity network is trained using input fields, having a name and/or a description, that are mapped to a hierarchical XDM field. For instance, data samples including mappings between raw input fields and XDM fields of the type <input field (name, description)->Hierarchical XDM field> are collected and used to train the field similarity network. An example of such a mapping is:

Input Field

Name: tracking code

Description: campaign identification

Mapped Hierarchical XDM Field—core.campaign.id

In the above example, the mapped XDM field includes three single level XDMs, namely ‘core’, ‘campaign’ and ‘id’ with ‘id’ being a leaf XDM node. The field similarity network is trained on the following pairs:

<‘tracking code campaign identification’; (‘core’: description)>,

<‘tracking code campaign identification’; (‘brand’: description)>, and

<‘tracking code campaign identification’; (‘name’: description)>

each with a similarity score of 1 as the final output. The ‘description’ in these pairs refers to the descriptions of the corresponding single level XDMs, which are available from the hierarchical XDM schema and is appended to the name of the corresponding single level XDM.

Along with these training pairs, the training data is augmented with other single level XDMs in the XDM schema with which the given input field does not match (with similarity score 0). For the above example, consider an XDM field ‘core.asset.name’, an additional pair—<‘tracking code campaign identification’; (‘asset’: description)>with similarity score 0 is also added. This is because the given field matches with ‘core’ at first level of the hierarchy while at the second level, it matches with ‘campaign’ and not ‘asset’. Such pairs are added at other levels of hierarchy also.

In some implementations, the field similarity network may be trained using hundreds or thousands or more input fields, with a name and/or a description, mapped to XDM fields. In one example, 500 input field to XDM mappings were used to train the field similarity network. Using the methodology described above, these mappings yield around 13000 pairs (input field—single level XDMs pairs) out which 9000 pairs were used for training the field similarity network. The remaining 4000 pairs were used for validation on which our trained model achieve a prediction accuracy of 95% which shows that the field similarity network achieves a high performance while matching given input field with single level XDMs.

Once the similarity scores are output 216, the similarity scores are input to the composition module 218 in the final phase. The composition module 218 composes the similarity scores of all single level XDMs in one path in the XDM tree to determine the probability of match with a single XDM field. The single level XDMs in one path in the XDM tree together compose a single XDM field. In order to calculate the probability of match between input field and a single XDM field, the field similarity network is used for determining the similarity scores with each constituent single level XDM in the XDM field. Each of these similarity scores is interpreted as probability of matching the field with the single level XDM. These are then composed to determine the final matching probability with the XDM field (constituted by these single level XDMs) by taking the product (intersection) of the individual probabilities. The XDM field with the highest probability is mapped to the input field.

For the above example, suppose the input field has the following similarity scores:

(Input field, ‘core’)—0.80

(Input field, ‘campaign’)—0.95

(Input field, ‘id’)—0.90

Then the probability of match between input field and ‘core.campaign.id’ is given as 0.85*0.99*0.95=0.799.

This is repeated for different XDM fields such that the one with the highest probability of match is predicted as the final XDM field to which the input field can be mapped.

Advantageously, the system and techniques can map input fields to custom XDM fields on which the LSTM model and/or the neural network have not been trained during training of the models. The models are designed to determine a similarity score between input field and single level XDMs without placing a constraint on the number and specificity of XDMs. The models accomplish this because the models determine similarity scores with all of the single level XDMs in the second phase so the number of XDM fields, which are paths of single level XDMs, aren't constrained because the neural network is only processing the similarity scores for the single level XDMs. Then, in the third phase, the similarity scores of the all single level XDMs in one path in the tree, which represent a single XDM field, are composed to determine the final probability score to find the best match to the input field. This flexibility is particularly advantageous since it is robust to the XDM evolution and can be used to provide suggestions while mapping input fields to new custom XDM fields without any change in the models. Advantageously, in some implementations, multiple input fields 202 can be mapped to a single XDM field in order to perform a many to one mapping using the mapping module 114 and the three phase architecture. The same techniques as described above for a single input field are applied to multiple input fields to map the multiple input fields to a single XDM field in the same manner.

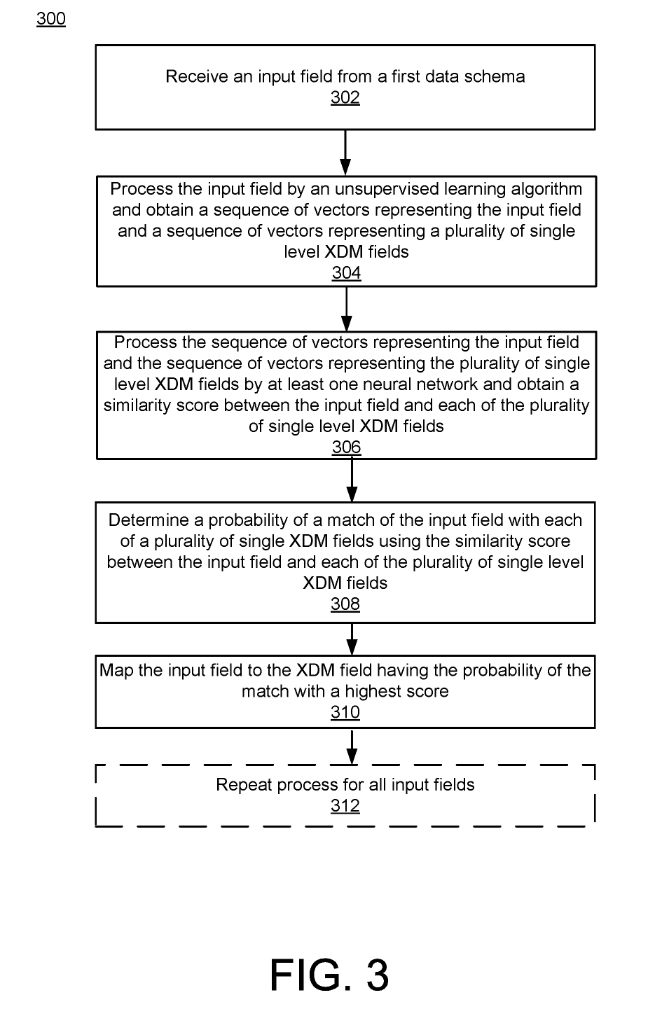

Referring to FIG. 3, an example process 300 illustrates the operations of the system 100 of FIG. 1, including the mapping module 114 as further detailed in FIG. 2. Process 300 may be implemented as a computer-implemented method and/or a computer program product for mapping an input field from a first data schema to XDM, where the XDM includes a tree of a plurality of single XDM fields and each of the single XDM fields includes a composition of a least one single level XDM field. Process 300 includes receiving an input field from a first data schema (302). For example, the mapping module 114 of FIG. 1, and specifically the unsupervised learning algorithm 204 of FIG. 2, receives an input field 202. The goal is to map the input field 202 to an XDM field.

The input field is processed by an unsupervised learning algorithm to obtain a sequence of vectors representing the input field and a sequence of vectors representing a plurality of single level XDM fields (304). For example, the unsupervised learning algorithm module 204 processes the input field 202 along with a single level XDM 203 to obtain a sequence of vectors representing the input field 206 and a sequence of vectors presenting a single level XDM 208. The input field may include a name of the input field or a description of the input field or both the name and the description. The unsupervised learning algorithm may include a GloVe model.

Process 300 includes processing the sequence of vectors representing the input field and the sequence of vectors representing the plurality of single level XDM fields by at least one neural network and obtaining a similarity score between the input field and each of the plurality of single level XDM fields (306). For example, the field similarity network, which is a second phase of the mapping module 114, processes the sequence of vectors representing the input field 206 and the sequence of vectors representing the single level XDM fields 208 and obtains a similarity score output 216 between the input field and each of the plurality of single level XDM fields. As discussed above, the field similarity network includes the LSTM model 210, the concatenation module 212 and the neural network layer 214.

More specifically, as discussed above with respect to FIG. 2 in detail, the sequence of vectors representing the input field 206 and the sequence of vectors representing single level XDM fields 208 are input to the LSTM model 210. To obtain vector representation of an input field 202, the sequence of vectors representing the input field 206, corresponding to words in the name and description of the input field are augmented as <name_{word vectors}: description_{word vectors}> and given as a sequential input to the LSTM model 210. The order in which the words appear in the name and description of the input field 202 determine the order in which the corresponding sequence of vectors representing the input field 206 are input to the LSTM model 210. The LSTM model 210 outputs a vector representing the entire input field 202. The output of the LSTM model 210 is used as the vector representing the entire input field. Likewise, the sequence of vectors representing the single level XDMs 208 is input into the LSTM model 210. The LSTM model 210 outputs a vector representing the single level XDM.

The concatenation module 212 concatenates the input field vector output from the LSTM model 210 with the vector representing the single level XDM output from the LSTM model 210. The concatenation module 212 outputs a concatenated vector. The concatenated vector is given as input to the neural network layer 214.

The neural network layer 214 may include one or more neural network layers through which the concatenated vector is processed. For example, the concatenated vector may be processed through a fully connected neural network layer, which may be referred to as a dense neural network layer. The output of the dense neural network layer may be input to a second neural network layer, which also may be a fully connected neural network layer. The second neural network layer, which may be of size 1, processes the output of the dense neural network layer and predicts a similarity score as an output. In some implementations, ‘sigmoid’ activation may be used over the output of the final neural network layer to obtain the final similarity score. This similarity score represents a probability of match between the input field and a single level XDM field.

Process 300 includes determining a probability of a match of the input field with each of a plurality of single XDM fields using the similarity score between the input field and each of the plurality of single level XDM fields (308). For example, the similarity score output 216 is input to the composition module 218, which composes a similarity score of all single level XDMs in the tree to determine the probability of a match with the single XDM field. The single level XDMs in one path in the XDM tree together compose a single XDM field. In order to calculate the probability of match between input field and a single XDM field, the field similarity network is used for determining the similarity scores with each constituent single level XDM in the XDM field. Each of these similarity scores is interpreted as probability of matching the field with the single level XDM. These are then composed to determine the final matching probability with the XDM field (constituted by these single level XDMs) by taking the product (intersection) of the individual probabilities.

Process 300 includes mapping the input field to the XDM field having the probability of the match with a highest score (310). Process 300 may be repeated for all input fields (312).

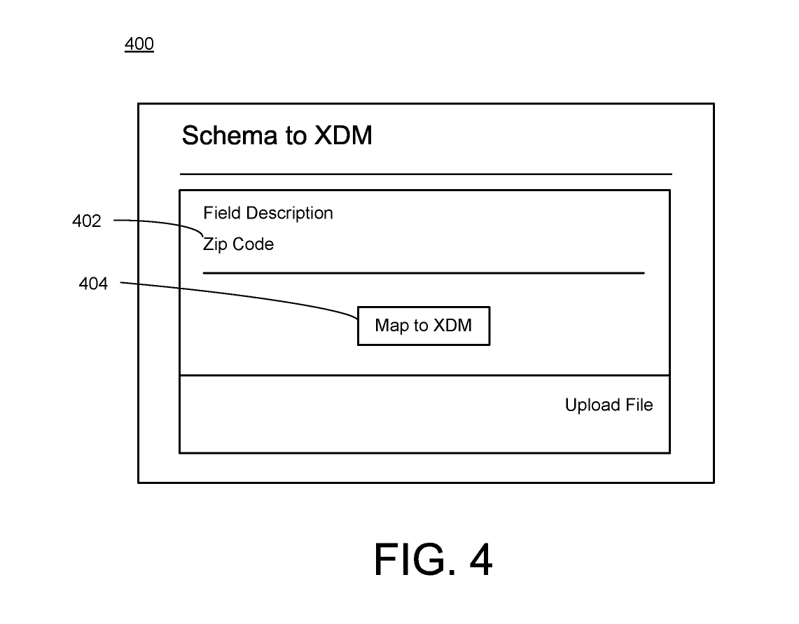

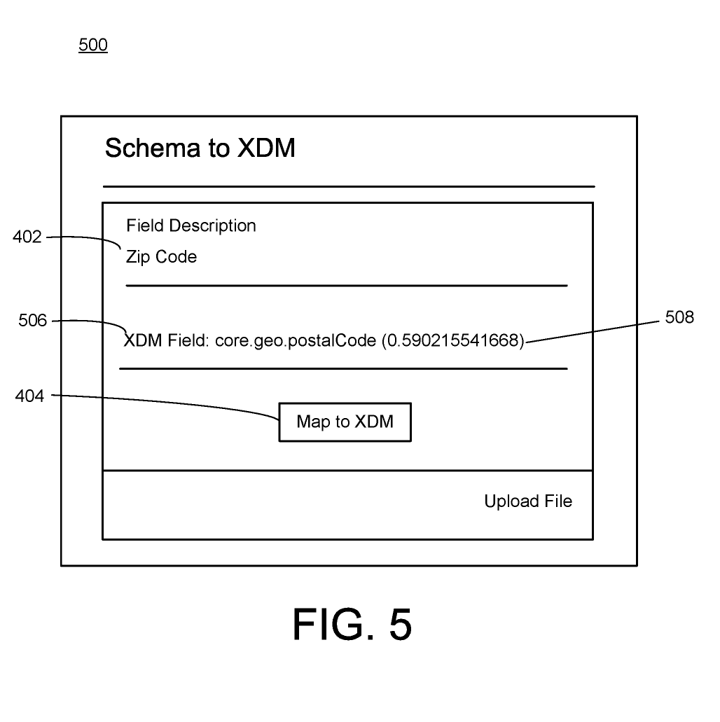

FIGS. 4-8 illustrate example screenshots of a user interface (e.g., user interface 112 of FIG. 1) of an application (e.g., application 108 of FIG. 1) for mapping input fields of a first data schema to XDM fields. For example, FIG. 4 illustrates an example screenshot 400 with an input field 402 having a field description of ‘zip code’. Selection of the button 404 ‘Map to XDM’ causes the input field 402 to be processed by the mapping module 114 of FIG. 1 to map the input field 402 to an XDM field. Referring also to FIG. 5, the screenshot 500 illustrates the result of mapping the input field 402 when the ‘Map to XDM’ button 404 is selected. In this example, the input field 402 having the field description of ‘zip code’ maps to the XDM field 506 ‘core.geo.postalCode’. The XDM field 506 also includes a value 508 indicating a probability of a match, which also may represent a confidence score of a match. A value greater than a threshold confidence score may be viewed as a good or reliable match.

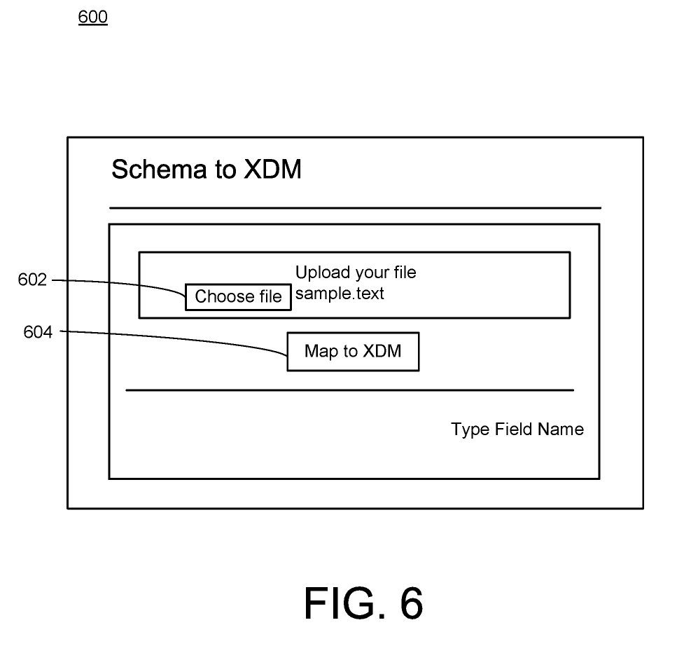

FIG. 6 is an example screenshot 600 of a user interface for uploading a file of input fields for mapping to XDM fields. In this example, the user interface includes a ‘choose file’ button 602 to enable a file of input fields to be uploaded to the application (e.g., application 108 of FIG. 1) to provide the input fields to the mapping module 114 for automatically mapping the input fields to XDM fields. The button 604 causes the mapping of the selected file of input fields to be processed by the mapping module 114 to output matching XDM fields for each of the input fields in the file.

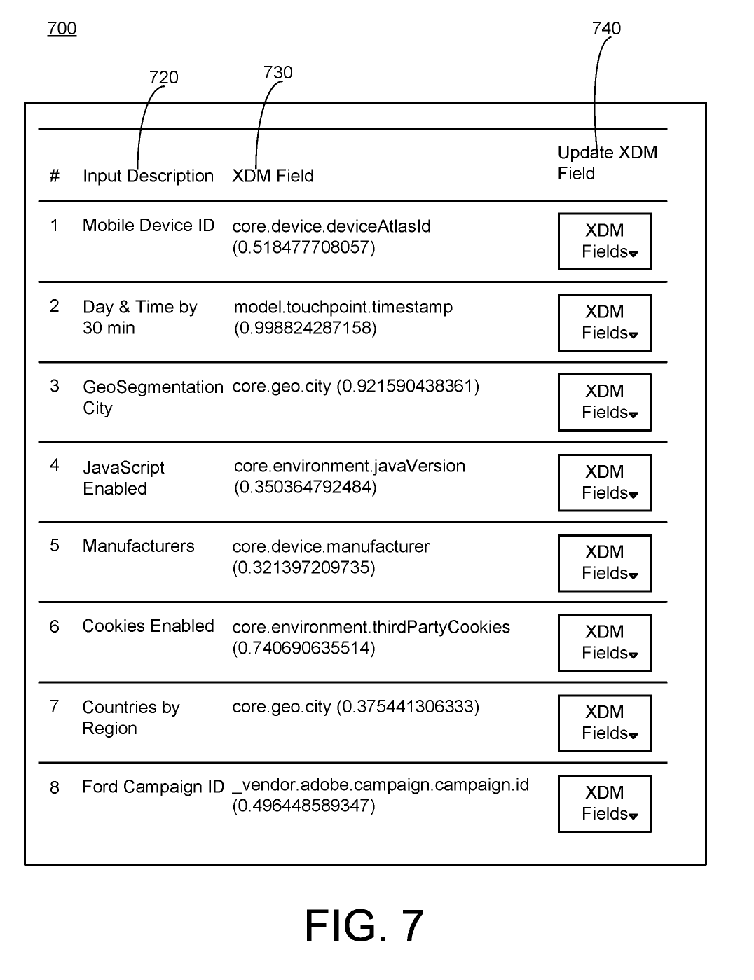

FIG. 7 is an example screenshot 700 of a user interface of results of multiple input fields mapping to respective XDM fields. In this example, the user interface illustrates a listing of multiple input fields 720 that have been mapped to a respective XDM field 730 by the mapping module 114. The input fields 720 include a description of the input field and the XDM field 730 includes the name of the XDM field and the probability of the match, which also may be referred to as a confidence score. The user interface also includes an option for updating each of the XDM fields 740. The update XDM field 740, when selected, provides a drop down listing of all the possible XDM field matches for an input field along with the confidence score. A user could manually override the automatically selected match and select a different XDM field to map to the input field.

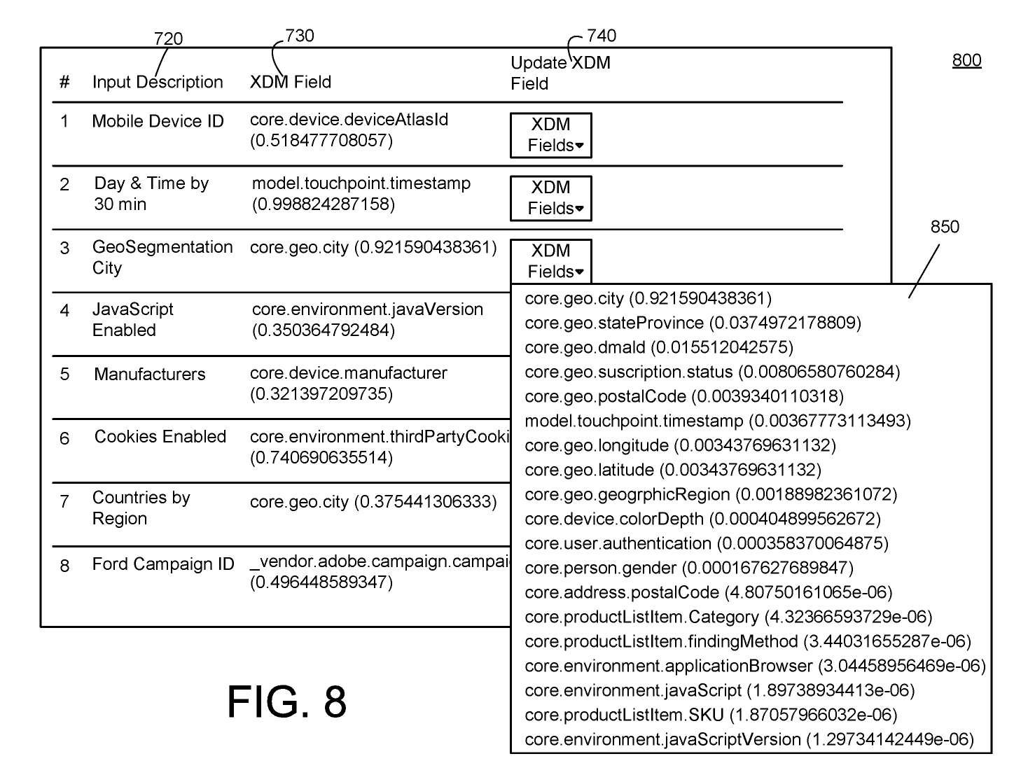

FIG. 8 is an example screenshot 800 of the user interface of FIG. 7 illustrating the XDM fields and the option to update the mapped XDM field. Each listing of the input fields 720 is mapped by the mapping module 114 to a respective XDM field 730, as shown in FIG. 7. In FIG. 8, the option to update the XDM field 740 is provided for each field and a selected XDM field 850 with the listing of all possible XDM fields and the confidence score are provided. In this manner, a user may manually select a different XDM field and override the XDM field that automatically mapped to the input field.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the embodiments.

What is claimed is:

1. A computer-implemented method for mapping an input field from a first data schema to a hierarchical standard data model (XDM), wherein the XDM includes a tree of a plurality of single XDM fields and each of the plurality of single XDM fields includes a composition of at least one single level XDM field, the method comprising:
receiving an input field from a first data schema;
processing the input field by an unsupervised learning algorithm and obtaining a sequence of vectors representing the input field and a sequence of vectors representing a plurality of single level hierarchical standard data model (XDM) fields;
processing the sequence of vectors representing the input field and the sequence of vectors representing the plurality of single level XDM fields by at least one neural network and obtaining a similarity score between the input field and each of the plurality of single level XDM fields;
determining a probability of a match of the input field with each of a plurality of single XDM fields using the similarity score between the input field and each of the plurality of single level XDM fields; and
mapping the input field to the XDM field having the probability of the match with a highest score.

2. The method as in claim 1, wherein the input field includes both a name of the input field and a description of the input field.

3. The method as in claim 1, wherein the input field includes only a description of the input field.

4. The method as in claim 1, wherein the unsupervised learning algorithm includes a global vectors for word representation (GloVe) model.

5. The method as in claim 1, wherein processing the sequence of vectors representing the input field and the sequence of vectors representing the plurality of single level XDM fields by at least one neural network comprises for each of the plurality of single level XDM fields:
processing the sequence of vectors representing the input field and the sequence of vectors representing the plurality of single level XDM fields using a long short-term memory (LSTM) model to obtain a vector representing the input field and a vector representing the single level XDM field;
concatenating the vector representing the input field and the vector representing the single level XDM field to obtain a concatenated vector; and
processing the concatenated vector using a neural network layer to obtain the similarity scores.

6. The method as in claim 1, wherein determining a probability of a match of the input field with each of a plurality of single XDM fields using the similarity score between the input field and each of the plurality of single level XDM fields comprises for each of the plurality of single XDM fields:
composing similarity scores for all single level XDM fields in one path in the tree to determine the probability of the match of the input field with the single XDM field.

7. The method as in claim 1, further comprising overriding the mapping of the input field to the XDM field having the probability of the match with the highest score by providing a user interface to select an XDM field having a score lower than the XDM field with the highest score.

8. A computer program product for mapping an input field from a first data schema to a hierarchical standard data model (XDM), wherein the XDM includes a tree of a plurality of single XDM fields and each of the plurality of single XDM fields includes a composition of at least one single level XDM field, the computer program product being tangibly embodied on a computer-readable storage medium and comprising instructions that, when executed by at least one computing device, are configured to cause the at least one computing device to:
receive an input field from a first data schema;
process the input field by an unsupervised learning algorithm and obtain a sequence of vectors representing the input field and a sequence of vectors representing a plurality of single level hierarchical standard data model (XDM) fields;
process the sequence of vectors representing the input field and the sequence of vectors representing the plurality of single level XDM fields by at least one neural network and obtain a similarity score between the input field and each of the plurality of single level XDM fields;
determine a probability of a match of the input field with each of a plurality of single XDM fields using the similarity score between the input field and each of the plurality of single level XDM fields; and
map the input field to the XDM field having the probability of the match with a highest score.

9. The computer program product of claim 8, wherein the input field includes both a name of the input field and a description of the input field.

10. The computer program product of claim 8, wherein the input field includes only a description of the input field.

11. The computer program product of claim 8, wherein the unsupervised learning algorithm includes a global vectors for word representation (GloVe) model.

12. The computer program product of claim 8, wherein the instructions that, when executed, cause the at least one computing device to process the sequence of vectors representing the input field and the sequence of vectors representing the plurality of single level XDM fields by at least one neural network comprises, for each of the plurality of single level XDM fields, instructions that, when executed, cause the at least one computing device to:
process the sequence of vectors representing the input field and the sequence of vectors representing the plurality of single level XDM fields using a long short-term memory (LSTM) model to obtain a vector representing the input field and a vector representing the single level XDM field;
concatenate the vector representing the input field and the vector representing the single level XDM field to obtain a concatenated vector; and
process the concatenated vector using a neural network layer to obtain the similarity scores.

13. The computer program product of claim 8, wherein the instructions that, when executed, cause the at least one computing device to determine a probability of a match of the input field with each of a plurality of single XDM fields using the similarity score between the input field and each of the plurality of single level XDM fields comprises, for each of the plurality of single XDM fields, instructions that, when executed, cause the at least one computing device to:
compose similarity scores for all single level XDM fields in one path in the tree to determine the probability of the match of the input field with the single XDM field.

14. A system for mapping an input field from a first data schema to a hierarchical standard data model (XDM), wherein the XDM includes a tree of a plurality of single XDM fields and each of the plurality of single XDM fields includes a composition of at least one single level XDM field, the system comprising:
at least one memory including instructions; and
at least one processor that is operably coupled to the at least one memory and that is arranged and configured to execute instructions that, when executed, cause the at least one processor to implement an application, the application comprising:
an unsupervised learning algorithm to receive an input field from a first data schema and process the input field to obtain a sequence of vectors representing the input field and a sequence of vectors representing a plurality of single level hierarchical standard data model (XDM) fields;
a field similarity network having at least one neural network to process the sequence of vectors representing the input field and the sequence of vectors representing the plurality of single level XDM fields to obtain a similarity score between the input field and each of the plurality of single level XDM fields; and
a composition module to determine a probability of a match of the input field with each of a plurality of single XDM fields using the similarity score between the input field and each of the plurality of single level XDM fields and map the input field to the XDM field having the probability of the match with a highest score.

15. The system of claim 14, wherein the input field includes both a name of the input field and a description of the input field.

16. The system of claim 14, wherein the input field includes only a description of the input field.

17. The system of claim 14, wherein the unsupervised learning algorithm includes a global vectors for word representation (GloVe) model.

18. The system of claim 14, wherein the field similarity network comprises:
a long short-term memory (LSTM) model to process the sequence of vectors representing the input field and the sequence of vectors representing the plurality of single level XDM fields to obtain a vector representing the input field and a vector representing the single level XDM field;
a concatenation module to concatenate the vector representing the input field and the vector representing the single level XDM field to obtain a concatenated vector; and
a neural network layer to process the concatenated vector to obtain the similarity scores.

19. The system of claim 14, wherein the composition module composes similarity scores for all single level XDM fields in one path in the tree to determine the probability of the match of the input field with the single XDM field.

20. The system of claim 14, further comprising a user interface to enable selection of an XDM field having a score lower than the XDM field with the highest score.
